(19) United States
(12) Patent Application Publication
(10) Pub. No.: US 2023/0140860 A1
(43) Pub. Date: May 11, 2023

(54) METHOD FOR PRODUCING A LAMINATION STACK FOR A ROTOR AND/OR A STATOR OF AN ELECTRIC MACHINE

(71) Applicant: Fischer & Kaufmann GmbH & Co. KG, Finnentrop (DE)

(72) Inventors: Jan GASTREICH, Finnentrop (DE); Tobias HEUTGER, Sundern (DE); Jürgen BISCHOPINK, Olpe (DE)

(73) Assignee: Fischer & Kaufmann GmbH & Co. KG, Finnentrop (DE)

(21) Appl. No.: 17/997,911

(22) PCT Filed: May 12, 2021
(86) PCT No.: PCT/EP2021/062594

§ 371 Date: Nov. 3, 2022

(30) Foreign Application Priority Data
Aug. 3, 2020 (EP) 20189124.9

(51) Int. Cl. H02K 15/02

(52) U.S. Cl. CPC H02K 15/024

(57) ABSTRACT

The invention relates to a method for producing a lamination stack for a rotor and/or a stator of an electric machine, wherein the lamination stack is produced of a stack of disk- or ring-shaped sheet metal laminations which are assembled of sub-segments that each have a radial outer edge, a radial inner edge and two lateral edges, wherein the sub-segments are stamped out of a sheet metal strip having a strip longitudinal direction that corresponds to a rolling direction of the sheet metal strip. In accordance with the invention provision is made in that for the purpose of stamping-out of the sheet metal strip first sub-segments are arranged in a first row and second sub-segments are arranged in a second row and stamped out, wherein the first row and the second row run in the strip longitudinal direction of the sheet metal strip and lie next to each other, in that the first sub-segments in the first row are aligned identically with respect to each other, wherein the radial outer edge and/or the radial inner edge run transversely to the longitudinal direction of the strip, and in that the second sub-segments in the second row are arranged identically with respect to each other, with radial outer edges and/or radial inner edges running transversely to the longitudinal direction of the strip, but diametrically opposed to the first sub-segments in the first row on the sheet metal strip.

The invention relates to a method for producing a lamination stack for a rotor and/or a stator of an electric machine, wherein the lamination stack is produced of a stack of disk- or ring-shaped sheet metal laminations which are assembled of sub-segments that each have a radial outer edge, a radial inner edge and two lateral edges, wherein the sub-segments are stamped out of a sheet metal strip having a strip longitudinal direction that corresponds to a rolling direction of the sheet metal strip, in accordance with the preamble of claim 1.

The invention further relates to a stator or a rotor of an electric machine, which is formed with a lamination stack, in accordance with the preamble of claim 8.

A generic method can be taken from DE 100 37 804 A1 for example. In this method a full ring for a ring-shaped stator is stamped out of a rolled sheet metal strip having a given rolling direction, wherein inside the inner waste portion sub-segments are arranged and stamped out to form a further stator. Compared to stamping out finished ring-shaped stators the suggested use of the inner circular waste portion results in an improved utilization of the material.

A comparable prior art is also known from document EP 2 693 604 A1. In this, a sufficiently well-known method is also described initially, in which ring-shaped sheet metal laminations are successively stamped out of a sheet metal strip so as to form a stator. To improve the utilization of the material it is taught that the ring-shaped sheet metal laminations are divided into sub-segments so that an improved use of the material can be realized.

A segmentation of ring-shaped sheet metal laminations to form a stator is also known from US 2012/0119599 A1 or from GB 2310545 A.

In addition to an economical use of the sheet metal strip a good property with regard to the magnetic flux is also of vital importance for a stator.

The invention is based on the object to produce a stator and/or a rotor for an electric machine particularly economically and at the same time with good electromagnetic properties.

The object is achieved on the one hand by a method having the features of claim 1 and on the other hand by a stator or rotor having the features of claim 8. Preferred embodiments of the invention are stated in the respective dependent claims.

The method according to the invention is characterized in that for the purpose of stamping-out of the sheet metal strip first sub-segments are arranged in a first row and second sub-segments are arranged in a second row and stamped out, wherein the first row and the second row run in the strip longitudinal direction of the sheet metal strip and lie next to each other, in that the first sub-segments in the first row are aligned identically with respect to each other, wherein the radial outer edge and/or the radial inner edge run transversely to the longitudinal direction of the strip, and in that the second sub-segments in the second row are arranged identically with respect to each other, with radial outer edges and/or radial inner edges running transversely to the longitudinal direction of the strip, but diametrically opposed to the first sub-segments in the first row on the sheet metal strip.

A basic idea of the invention first of all resides in the fact that the sheet metal laminations used for a lamination stack to form a ring-shaped stator or a disk-shaped rotor are divided into sub-segments that can be assembled to the stator or rotor. This makes it possible to arrange the sub-segments in a particularly efficient way on a sheet metal strip to keep a waste portion on a low level.

Moreover, one aspect of the invention resides in the fact that the individual sub-segments are not arbitrarily arranged and stamped out on a sheet metal strip. In fact, a row arrangement of the sub-segments is provided, in which case these rows run in the longitudinal direction of a sheet metal strip which is at the same time a rolling direction of the sheet metal strip.

When rolling a sheet metal strip the process results in a stretching of the metal grains in the sheet metal strip in the longitudinal direction of rolling or rather in the longitudinal direction of the strip. The sub-segments in each row are arranged identically or parallel to each other such that the radial outer edges and/or the radial inner edges run transversely to the longitudinal direction of the strip. Hence, in their radial direction the sub-segments preferably have a stretched shape of the material grains in the metal structure. This radially directed stretching and alignment of the grain structure in the sheet metal laminations proves to be advantageous for the magnetic flux and the electromagnetic behavior when used in an electric machine, especially an electric motor or an electric generator. As a result, the efficiency of the electric machine can be increased.

A particularly economical and technically advantageous arrangement of the sub-segments is achieved in that at least two rows of sub-segments are chosen next to each other along the longitudinal direction of the strip, with first sub-segments in the first row being arranged identically with respect to each other, while the second sub-segments in the second row are arranged and stamped out at 180° with respect thereto, thus being diametrically opposed to the arrangement in the first row. As a result, almost identical and consistent electromagnetic properties can be realized in all sub-segments due to the largely identical alignment of the metal grains of the sheet metal strip in a radial direction of the arched sub-segments.

When assembling the sub-segments to the stator or rotor it is therefore also possible to realize almost identical radial alignments of the metal grains over the circumference and thus almost identical electromagnetic properties. This is advantageous for an especially smooth running or operation of an electric machine produced of a stator and/or a rotor that are constructed using lamination stacks with sub-segments produced in this way.

Basically, the first sub-segments and the second sub-segments can be designed differently to each other, in particular having a different size and/or a different arc section. According to a further development of the invention it is particularly advantageous that the first sub-segments and the second sub-segments are designed identically. This allows a particularly economical production even of lower-cost sheet metal qualities.

For an arrangement and stretching of the grain structure in the most identically aligned way possible in a radial direction of a stator or rotor, with regard to the dimensioning of the sub-segments it is expedient that a circular arc section or a circular arc angle of the respective sub-segment is as small as possible, in particular ranging between 20° and 120°. According to an embodiment of the invention it is particularly expedient that the sub-segments are designed as quarter circular arc segments. In the case of a quarter circular arc segment the sheet metal lamination extends over an arc of 90° of the circumference of the stator or rotor. The stator or rotor is then assembled of a total of four sub-segments over the circumference. However, provision can also be made for only three sub-segments of 120° each or more sub-segments, such as five sub-segments of 72° each, six sub-segments of 60° each etc.

To assemble the sub-segments to a full circumference it is furthermore advantageous according to an embodiment variant of the invention that in order to form a tongue-and-groove connection when assembling the sub-segments each sub-segment is stamped out with a groove on a first lateral edge and with a matching tongue on the opposite second lateral edge. The tongue-and-grove connection is thus directed in the circumferential direction. This can be a simple plug-in tongue-and-groove connection or additionally have an undercut, as in a dovetail connection for example, to bring about a form-locking effect also in the circumferential direction. Within the meaning of the invention a tongue is in particular a lug or a projection on a lateral edge of the sub-segment, in which case the lug is designed to match the groove.

The sub-segments are based on the shape of a ring-shaped stator or a disk-shaped rotor which is usually designed with a center opening for application onto a shaft. A preferred embodiment of the invention resides in the fact that the sub-segments have radially directed webs that are substantially aligned in the longitudinal direction of the strip. The radially directed webs are preferably arranged on a radial inner edge of the sub-segments. By preference, the webs can be heat-treated after stamping to achieve a further improvement of the grain structure.

For a magnetic flux it is particularly advantageous in these radially directed webs that a radially directed stretching of the grain structure is given in these areas.

A lamination stack can be constructed of a few sheet metal laminations up to several hundred sheet metal laminations. The thickness of a sheet metal lamination can preferably range between 0.1 mm and up to 2 mm. For axial stacking of the sheet metal laminations, according to a further development of the invention it is advantageous that for the purpose of interlocking, the sub-segments are provided with form-locking elements perpendicular to the strip plane. In particular, indentations can be made transversely to the strip plane on one side of the strip, the said indentations resulting in a projection on the opposite side of the sheet metal lamination. The form-locking elements can be designed not only as indentations but also as stampings and chamfers. Additionally or alternatively, adhesive bonding of the sheet metal laminations can take place.

According to a method variant pursuant to the invention it is especially efficient that this is carried out on a press with at least one stamping tool and preferably at least one embossing tool. Where appropriate, provision can also be made for at least one bending tool on the press. In the case of several tools these are preferably designed as a follow-on composite tool in a single press. In this, the individual tools are arranged in series one behind the other, wherein after each press stroke the partially processed workpiece is transferred to the subsequent tool.

The invention furthermore relates to a stator or rotor of an electric machine which is formed with a lamination stack which, in accordance with the invention, is produced with sub-segments pursuant to the previously described method. Within the meaning of the invention an electric machine can in particular be an electric motor or an electric generator. By preference, the stator is constructed in a ring-shaped manner of ring-shaped sheet metal laminations and/or the rotor of disk-shaped sheet metal laminations.

According to a further development of the invention it is especially advantageous that the disk-shaped rotor or the ring-shaped stator is formed only of first sub-segments or only of second sub-segments. By producing the rotor and the stator only of sub-segments from a single row particularly uniform magnetic flux properties can be achieved in the component and thus a high degree of efficiency in an electric machine.

Alternatively, according to a further development of the invention provision is made in that the disk-shaped rotor or the ring-shaped stator is formed of first sub-segments and of second sub-segments. This simplifies the production as a whole, and due to the largely identical alignment of the grains in the sheet metal strip good magnetic flux properties continue to be achieved in the components.

Furthermore, the invention comprises an electric machine, in particular an electric motor or a generator which are characterized in that a stator and/or rotor according to the invention is installed.

The invention is explained further hereinafter by way of preferred embodiments illustrated schematically in the drawings, wherein show:

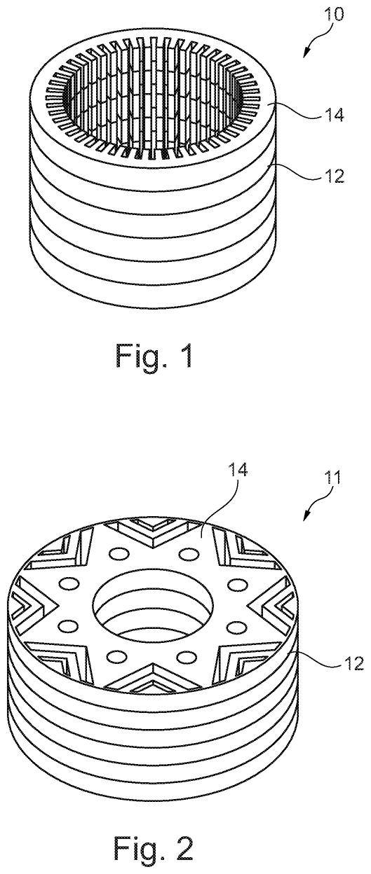

FIG. 1 a perspective view of a stator constructed according to the invention;

FIG. 2 a perspective view of a rotor constructed according to the invention;

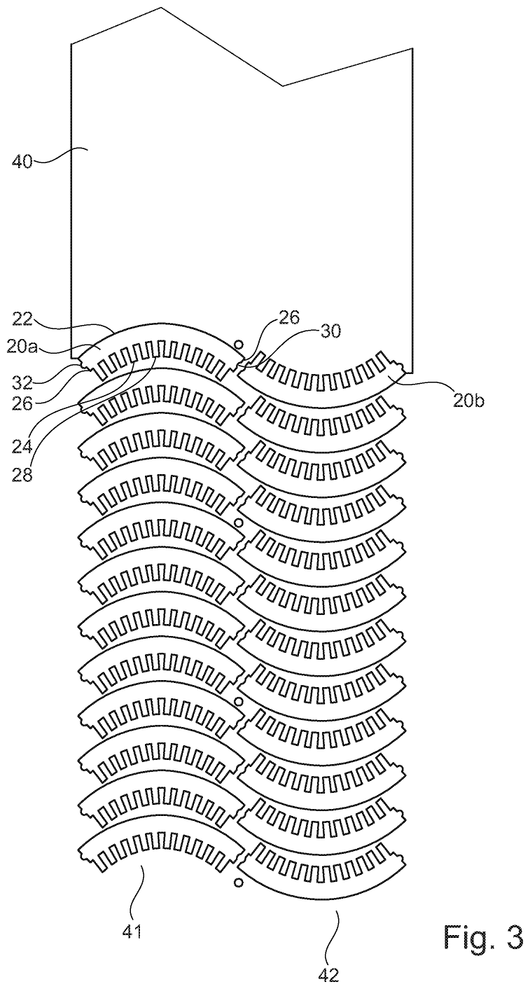

FIG. 3 a perspective view of the arrangement of sub-segments on a sheet metal strip according to the invention;

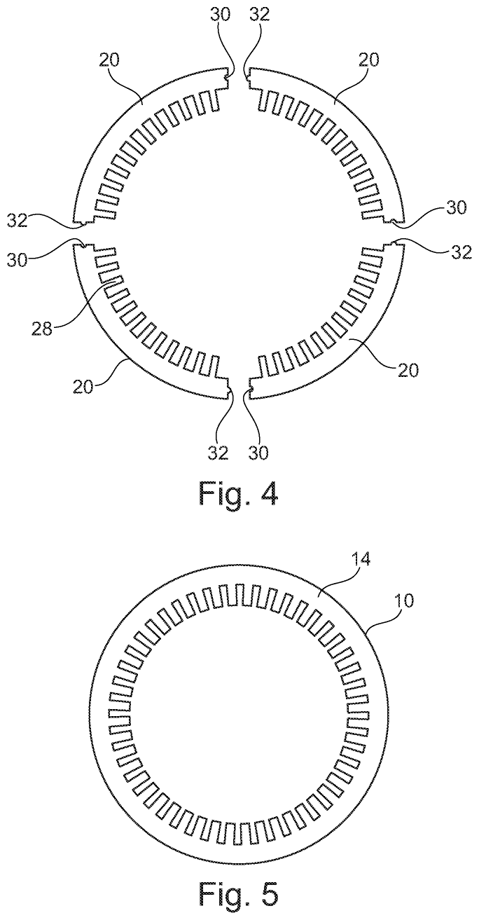

FIG. 4 an assembly of a stator ring of four sub-segments; and

FIG. 5 a plan view of an assembled stator ring.

In FIG. 1 a stator 10 produced according to the invention for an electric motor is illustrated, wherein the stator 10 is formed of a lamination stack 12 of a plurality of axially stacked ring-shaped sheet metal laminations 14.

In FIG. 2 a rotor 11 produced according to the invention is constructed of a lamination stack 12 of substantially disk-shaped sheet metal laminations 14. The construction of a stator 10 or a rotor 11 of a plurality of thin sheet metal laminations 14 improves the electromagnetic behavior of the electric motor or a corresponding electric generator and thus the efficiency of the respective electric machine.

To further improve the efficiency the individual sheet metal laminations 14 are divided into sub-segments 20 which are arranged in a manner according to the invention on a sheet metal strip 40 in at least two rows, namely a first row 41 and a second row 42, in the longitudinal direction of the sheet metal strip 40 and are thus stamped out. The invention is based on the finding that when rolling a sheet metal strip 40, especially when cold rolling it, a stretching and alignment of the grain structure arises in the metal material. According to a finding of the invention such a stretching and alignment of the grain structure can enhance the efficiency of an electric machine if this stretching is as uniform as possible in a radial direction in a stator 10 or rotor 11.

According to the invention such an alignment is achieved in that a ring shape is divided into several arched sub-segments that deviate only slightly from a straight line. In the first row 41 first sub-segments 20a are aligned one behind the other and identically in the longitudinal direction of the sheet metal strip 40. In doing so, a radial outer edge 22 and a radial inner edge 24, on which radially directed webs 28 are designed, run substantially transversely to the longitudinal direction of the sheet metal strip 40. At the same time, a groove 30 can be designed on a first lateral edge 26 of a sub-segment 20 and a projecting tongue 32 can be designed on a second lateral edge 26 of the same sub-segment 20. The approximately V-shaped groove 30 and the matching arrow-like designed tongue 32 are on the whole designed such that they can engage in a form-locking manner to establish a tongue-and-groove connection.

According to the invention a very good utilization of the material of the sheet metal strip 40 is realized in that in the second row 42 the second sub-segments 20b are arranged diametrically opposed to the first sub-segments 20a in the first row 41 on the sheet metal strip 40 and are stamped out of the latter. Despite the fact that the second sub-segments 20b are arranged by being rotated by 180° in the longitudinal direction of the sheet metal strip 40 a largely equally good alignment of the second sub-segments 20b in the longitudinal direction and thus also in the rolling direction of the sheet metal strip 40 is achieved as in the case of the first sub-segments 20a in the first row 41.

The first sub-segments 20a in the first row 41 and the second sub-segments 20b in the second row 42 are arranged next to each other such that the respective lateral edges 26 with the grooves 30 lie directly opposite so that, in a particularly material-saving way, no or only a minimal intermediate web remains in-between the two sub-segments 20a, 20b. The respective lateral edges 26 with the projecting tongues 32 are in each case directed outwards.

Following stamping-out of the sub-segments 20 the webs 28 on the respective inner edge 24 can still undergo thermal treatment, whereby an even finer grain structure can be adjusted in these material regions e.g. through solution annealing.

As illustrated in FIGS. 4 and 5, in this preferred embodiment the sub-segments 20 are designed as a quarter circular arc segment so that a total of four sub-segments 20 can be assembled to a ring of a stator 10. The sub-segments 20 are arranged with respect to each other in such a manner that the lateral groove 30 and the lateral tongue 32 of two adjacent sub-segments 20 lie opposite in each case. Through appropriate assembly a closed ring-shaped sheet metal lamination 14 can thus be formed for a stator 10. Before being assembled to a ring the individual sub-segments 20 can be stacked axially so that corresponding sheet metal stacks 12 can be assembled with each other to form a ring. Alternatively, a single ring-shaped lamination 14 can also be assembled initially, and subsequently a plurality of assembled sheet metal laminations 14 are stacked axially to the sheet metal stack 12 for a stator 10.

The procedure can be applied correspondingly to a rotor 11 which can also be assembled of several sub-segments 20.

1-11. (canceled)

12. A method for producing a lamination stack for a rotor and/or a stator of an electric machine,
wherein the lamination stack comprises a stack of disk- or ring-shaped sheet metal laminations which are assembled of sub-segments that each have a radial outer edge, a radial inner edge and two lateral edges, wherein the sub-segments are stamped out of a sheet metal strip having a strip longitudinal direction that corresponds to a rolling direction of the sheet metal strip, the method comprising:
arranging first sub-segments in a first row and arranging second sub-segments in a second row,
wherein the first row and the second row are aligned in the strip longitudinal direction of the sheet metal strip and lie next to each other,
wherein the first sub-segments in the first row are aligned identically with respect to each other, wherein the radial outer edge and/or the radial inner edge run transversely to the longitudinal direction of the strip,
wherein the second sub-segments in the second row are arranged identically with respect to each other, with radial outer edges and/or radial inner edges running transversely to the longitudinal direction of the strip, but diametrically opposed to the first sub-segments in the first row on the sheet metal strip,
wherein a circular arc section or a circular arc angle of the respective sub-segment ranges between 20° and 120°; and
stamping out the sheet metal strip such that each sub-segment is stamped out with a groove on a first lateral edge and with a matching tongue on the opposite second lateral edge in order to form a tongue and groove joint to allow for assembling the sub-segments to a sheet metal lamination.

13. The method according to claim 12,
wherein the first sub-segments and the second sub-segments are designed identically.

14. The method according to claim 12,
wherein the sub-segments are designed as quarter circular arc segments.

15. The method according to claim 12,
wherein the sub-segments have radially directed webs that are substantially aligned in the longitudinal direction of the strip.

16. The method according to claim 12,
wherein for the purpose of the interlocking, the sub-segments are provided with form-locking elements perpendicular to the strip plane.

17. The method according to claim 12,
wherein the stamping step is performed on a press with at least one stamping tool and/or at least one embossing tool.

18. The method according to claim 12,
wherein a stator or rotor of an electric machine is formed, which is formed with a lamination stack, and
wherein the lamination stack is produced with sub-segments.

19. The method according to claim 18,
wherein a disk-shaped rotor or a ring-shaped stator is formed only of first sub-segments or only of second sub-segments.

20. The method according to claim 18,
wherein a disk-shaped rotor or a ring-shaped stator is formed of first sub-segments and of second sub-segments.

21. The method according to claim 12,
wherein an electric machine is formed with the stator and/or rotor.
